(19) United States
(12) Patent Application Publication
(10) Pub. No.: US 2008/0203704 A1
(43) Pub. Date: Aug. 28, 2008

(54) FOLDABLE STAND FOR SUPPORTING A POWER TOOL

(76) Inventors: Robert E. McCracken, Anderson, SC (US); Ryan Harrison, Anderson, SC (US); Adam Radzinski, Greenville, SC (US); Thomas D. Evatt, Six Mile, SC (US); James A. Keith, Pickens, SC (US)

Correspondence Address: TTi/BRINKS HOFER GILSON & LIONE, P.O.BOX 10395, CHICAGO, IL, 60610, US

(21) Appl. No.: 11/679,530

(22) Filed: Feb. 27, 2007

(51) Int. Cl. B62B 1/04

(52) U.S. Cl. 280/651

(57) ABSTRACT

A foldable stand for holding a power tool is provided. The stand includes a platform and a first leg rotatably mounted to the platform. A bracket is mounted to the platform and includes a first hook engageable with a first portion of the first leg to maintain the first leg in a first position, and a second hook engageable with a second portion of the first leg to maintain the first leg in a different second position.

### BACKGROUND

It is common in the construction industry for a user to bring tools to a worksite for the sake of convenience and efficiency. Many power tools, such as miter saws and the like are extremely heavy, which makes it prohibitive to carry these types of tools extended distances to a job site. Accordingly, it is common to mount power tools on a cart, foldable stand, or other type of transport apparatus to assist in moving a power tool to the job site. Many conventional carts or stands are foldable, but are relatively unwieldy and difficult to fold and unfold with a power tool attached. Additionally, many carts or stands do not include locking mechanisms for both the folded position and the unfolded position for using the power tool. Also, it is known to provide an arm that extends from the stand to support a roller or other type of support for a workpiece that extends from the cutting region of the power tool. While many carts include extendable arms, these arms are not capable of holding a relatively heavy work piece, or the arm must be used with an external member to support the extended end of the arm.

### SUMMARY

A first representative embodiment of the present invention provides a foldable stand that includes a platform and a plurality of legs rotatably mounted to the platform. An extension arm is telescopically mounted to the platform and a support leg rotatably and telescopically mounted to the extension arm.

A second representative embodiment of the present invention provides a foldable stand that includes a platform and a first leg rotatably mounted to the platform. A bracket is mounted to the platform and includes a first hook engageable with a first portion of the first leg to maintain the first leg in a first position, and a second hook engageable with a second portion of the first leg to maintain the first leg in a different second position.

A third representative embodiment of the present invention provides a foldable stand that includes a platform and a leg rotatably mounted to the platform. A bracket is mounted to the platform and includes a first hook engageable with a first portion of the leg to maintain the leg in an extended position from the platform.

Advantages of the present disclosure will become more apparent to those skilled in the art from the following description of the preferred embodiments of the invention that have been shown and described by way of illustration. As will be realized, the disclosure is capable of other and different embodiments, and its details are capable of modification in various respects. Accordingly, the drawings and description are to be regarded as illustrative in nature and not as restrictive.

### DESCRIPTION OF THE DRAWINGS

FIG. 1 is a top perspective view of a saw stand.

FIG. 2 is another top perspective view of the saw stand of FIG. 1.

FIG. 3 is a bottom perspective view of a portion of the saw stand of FIG. 1.

FIG. 4 is a side view of the saw stand of FIG. 1.

FIG. 5 is a perspective view of the extension arm, support leg, and adjustment leg of FIG. 1.

FIG. 6 is another perspective view of the extension arm, support leg, and adjustment leg of FIG. 1.

FIG. 7 is a perspective view of the adjustment leg and associated actuator of the saw stand of FIG. 1.

FIG. 7A is a detail view of detail A of FIG. 7.

FIG. 8A is a side view of the saw stand of FIG. 5 in the use position.

FIG. 8B is the view of FIG. 8A in the intermediate position.

FIG. 8C is the view of FIG. 8A with the adjustment leg and support leg partially telescopically received within the extension arm.

FIG. 9 is a perspective view of the bracket of FIG. 1.

FIGS. 10a through 10e depict the sequence of steps to transfer the saw stand from the transport position to the use position.

FIG. 11 is a perspective view of the platform of the saw stand of FIG. 1.

### DESCRIPTION

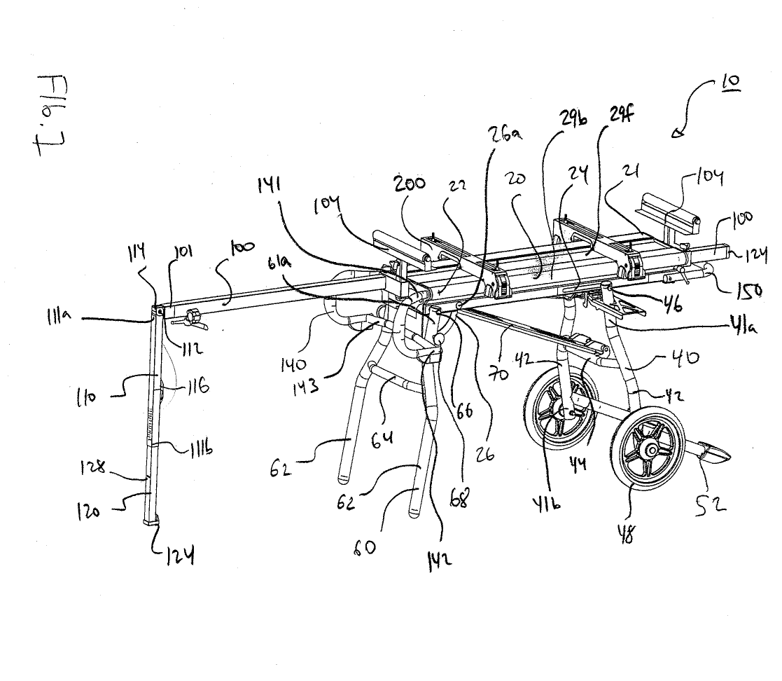

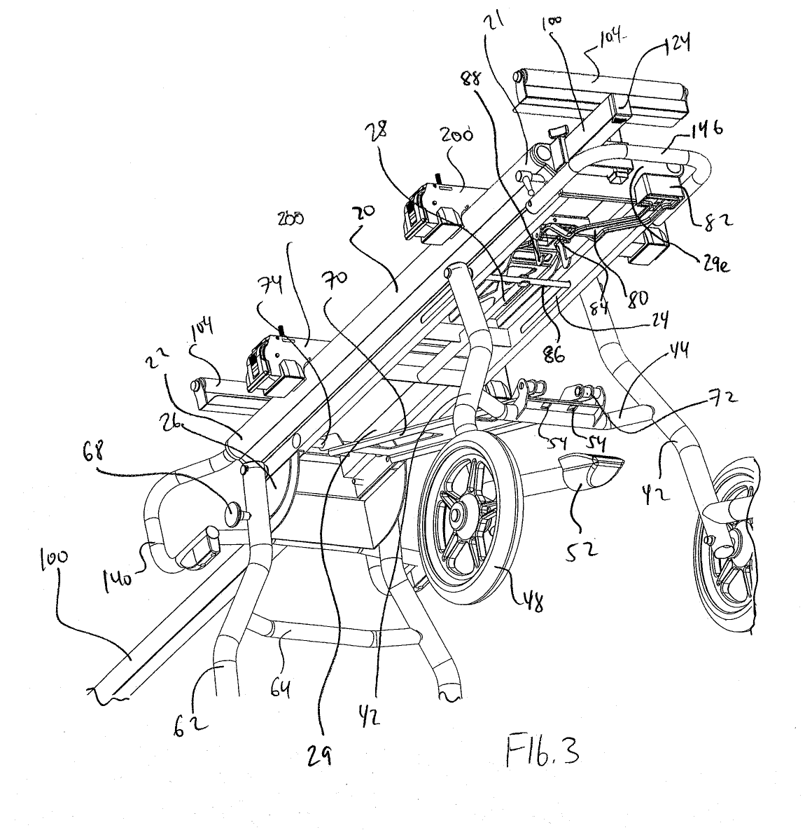

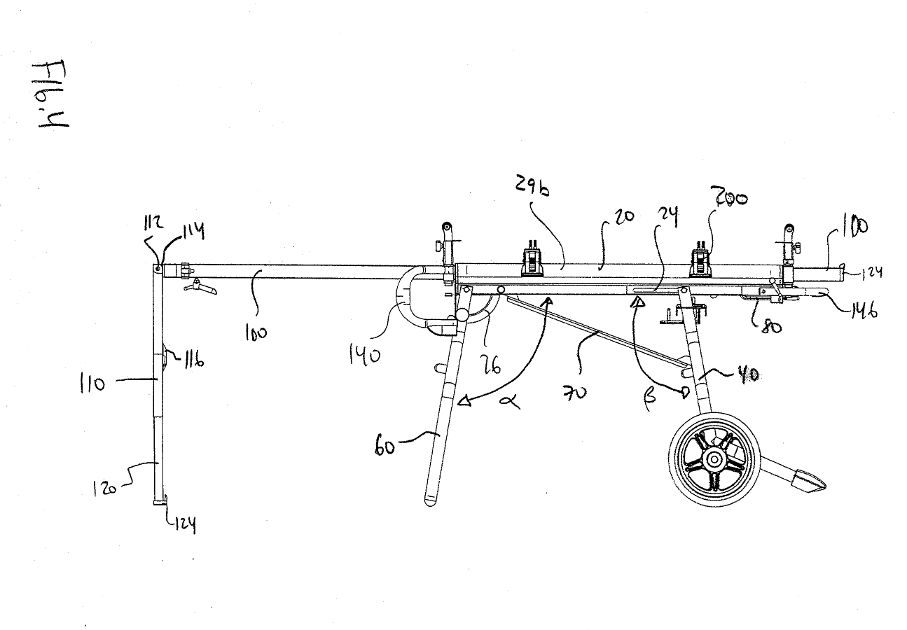

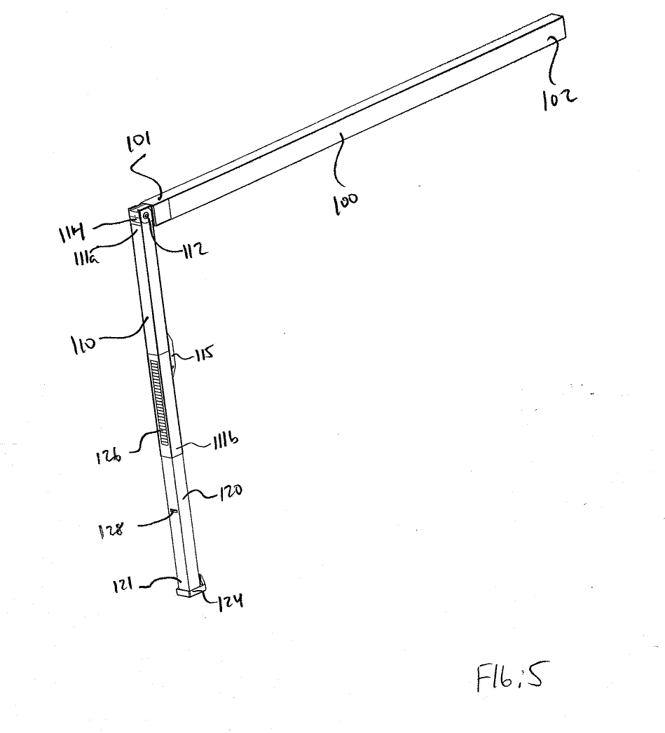

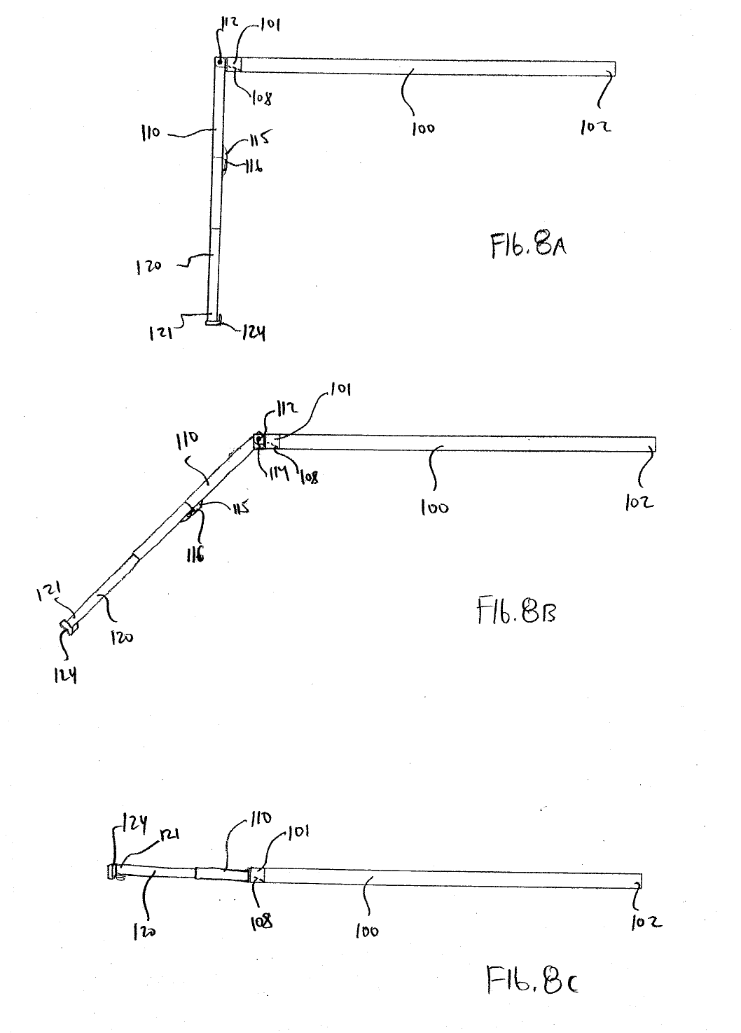

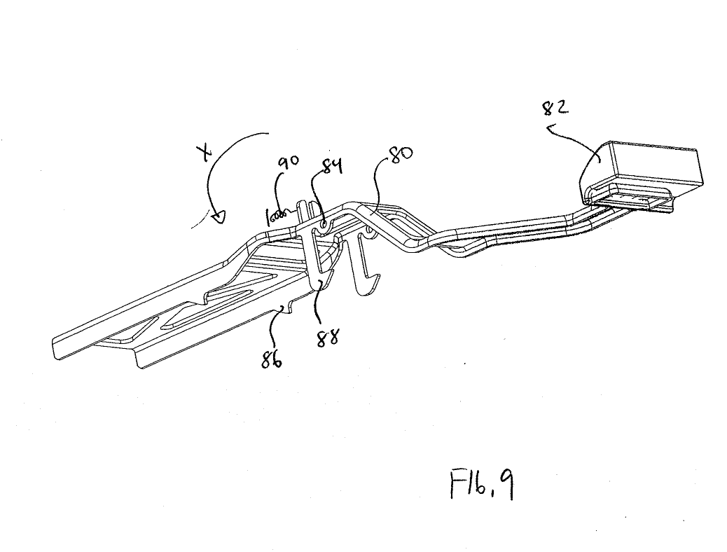

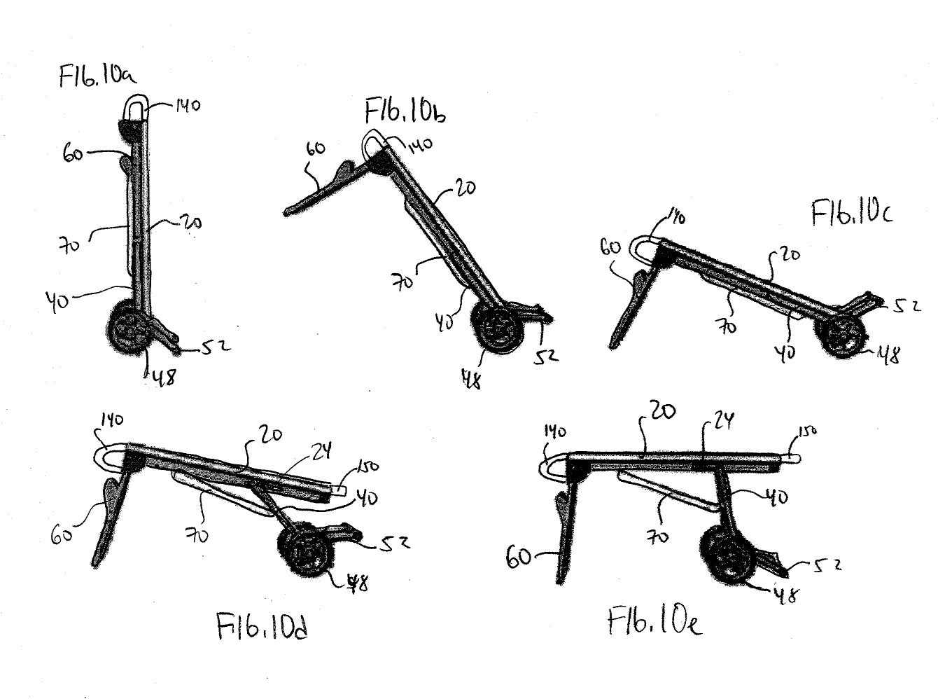

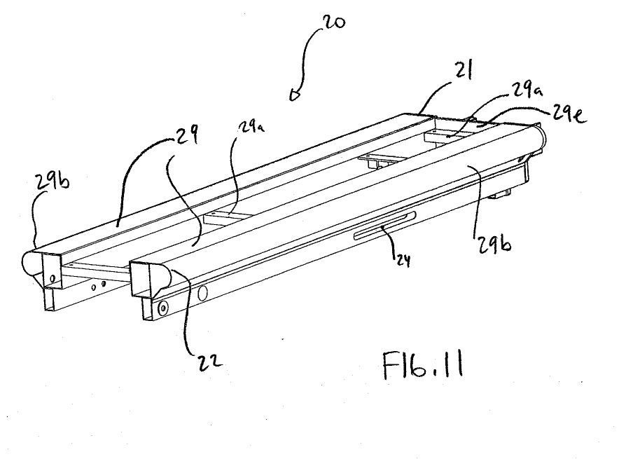

Referring now to the embodiments shown in FIGS. 1-11, a foldable saw stand 10 is provided. The saw stand 10 is foldable between a use position (best shown in FIG. 1) where the platform 20 is positioned substantially parallel to the ground to provide the platform 20 at a suitable height above the ground for using a miter saw (not shown) or other tool that is mounted to the saw stand 10. When the saw stand 10 is in the use position, the first and second sets of foldable legs 40, 60 are oriented substantially perpendicular to, or at a large acute or small obtuse angle β with respect to the platform 20. The first and second sets of legs 40, 60 are foldable with respect to the platform 20 to collapse the saw stand 10 into a transport, or retracted position (FIG. 10a). The saw stand 10 additionally includes a link 70 that is pivotably connected to both the platform 20 and the first set of legs 40 to constrain the range of potential motion of the first set of legs 40 and to provide structural and mechanical support to the saw stand 10.

A bracket 80 is pivotally mounted to the underside of the platform 20 and includes first and second hooks 86, 88 that selectively engage alternate portions of the first set of legs 40 to retain the first set of legs 40 in either the use position or the transport position. The bracket 80 is biased toward engagement between either of the first or second hooks 86, 88 and an appropriate portion of the first set of legs 40. The bracket 80 includes an actuator 82 that allows the user to rotate the bracket 80 against the biasing force of a spring 90 to disengage first or second hooks 86, 88 from the first set of legs 40 to allow for rotation between the use and transport positions.

Extension arms 100 are telescopically provided on one or both ends of the platform 20. The extension arms 100 are retractable from the platform 20 to provide a track for linear movement of a workpiece roller support 104 or similar member that can provide support for a portion of a workpiece that is not in the vicinity of the working zone of the tool. The extension arm 100 includes a support leg 110 that is pivotally and telescopically connected with the extension arm 100 to provide mechanical support for the extended end 101 of the extension arm 100. An adjustment leg 120 may be telescopically received within the support leg 110 to adjust the height of the column mechanically supporting the extended end 101 of the extension arm 100.

As best shown in FIGS. 1-3 and 11, the platform 20 may be formed from two parallel hollow beams 29 that are joined together with a plurality of cross beams 29a at various spaced apart locations along the length of the beams 29. The two beams 29 may include a profile that is substantially rectangular with an internal volume slightly larger than the outer volume of an extension arm 100. The opposed outer surfaces of each beam 29 receives an arcuate surface 29b along the length of each beam 29 that receives one of the two clamping members of the releasable mounting bracket 200. The releasable mounting brackets 200 are suitable for receiving and retaining a miter saw or other type of bench-top power tool on the platform 20. Applicants filed a utility patent application on, Feb. 27, 2007, the same date that the subject patent application was filed, U.S. application Ser. No. ______, titled “Bracket” (attorney reference number 10710-1024), which is fully incorporated by reference herein and discloses the structure and operation of the mounting bracket 200 with respect to the saw stand 10.

The first and second ends 21, 22 of the platform 20 may each receive an end cap 29e that encloses the hollow beams 29 and arcuate surface 29b and includes an aperture for the extension arm 100 to extend therethrough into the platform 20 as necessary. The platform 20 may further include a top surface 29f (FIG. 1) that provides a support surface for items placed on the platform 20 when in the use position.

The first set of legs 40 is pivotably and slidably connected in the proximity of the first end 21 of the platform 20. Specifically, the first set of legs 40 is pivotably and slidably connected to a slot 24 defined within the platform 20. The first set of legs 40 includes two or more leg members 42 with first ends 41a that are each pivotably and slidably connected to the platform 20. The leg members 42 may be joined by a cross member 44. A second end 41b of the leg members 42 each may include a wheel 48 rotatably connected to the leg member 42 and a stopping leg 52 extending from the leg member 42. The wheel 48 allows the saw stand 10 to be rolled by the user when in the transport position. The stopping legs 52 provide mechanical support for added stability when the saw stand is in the transport position (with the platform 20 oriented substantially perpendicular to the ground, best shown in FIG. 10a), and when the saw stand 10 is in the use position.

Opposite ends of the link 70 are pivotally connected to the platform 20 and the first set of legs 40, respectively. Specifically, the link 70 may be pivotally connected to the cross member 44 of the first set of legs 40. As discussed above, the link 70 constrains the range of motion of the first set of legs 40 to that shown between FIGS. 10c and 10e.

The second set of legs 60 are rotatably connected to the platform 20 at a second end 22 of the platform 20. The second set of legs 60 is formed from two or more leg members 62 that are each pivotably connected to the second end 22 of the platform 20 with a pinned connection 66. The leg members 62 may be joined together with a cross member 64. In the use position, the second set of legs 60 is substantially perpendicular to or at a large acute or a small obtuse angle α with respect to the platform 20. In the transport position, the second set of legs 60 are substantially parallel to the platform 20.

The second set of legs 60 may include a locking member 68 provided near the first end 61a of at least one or more of the second legs 62. The locking member 68 is engageable with one or more holes 26a in a hinge member 26 mounted to the platform 20 to maintain the second set of legs 60 in the selected position. A first hole 26a is provided in proximity to the platform 20 to receive the locking member 68 when the second set of legs 60 are in the transport position and a second hole 26a is defined at an angle α from the first hole 26a to receive the locking member 68 when the second set of legs 60 are in the use position.

With specific reference to FIGS. 1, 9, and 10a-10e, a bracket 80 is provided to selectively retain the first set of legs 40 in either the use position (FIG. 1) or the transport position (FIG. 10a). The bracket 80 is pivotably mounted to the platform 20 on the side of the platform 20 opposite from that receiving one or more releasable mounting brackets 200.

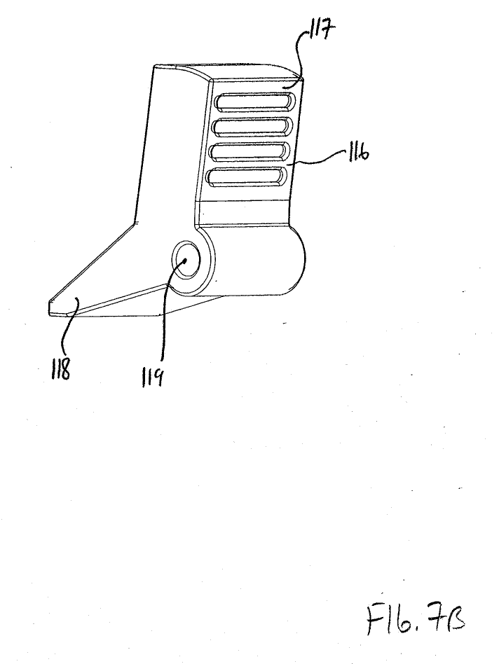

The bracket 80 is pivotally mounted to the underside surface of the platform 20 (i.e. the surface opposite the surface receiving the mounting brackets 200) with a pinned connection 84. The locking bracket 80 is biased in a rotational direction X (best shown in FIG. 9) by a biasing member 90, such as a spring.

The locking bracket 80 further includes a first hook 86 and a second hook 88, that each extend from the locking bracket 80. In some embodiments, the first and second hooks 86, 88 may each be formed from two or more hooks 86, 88 that extend in parallel from the locking bracket 80, or in another manner to engage the respective locking portion of the set of first legs 40. In other embodiments, the first and second hooks 86, 88 may each be formed from a single hook.

The first hook 86 is selectively engageable with a pin 46 that extends through a first end of each of the two leg members 42 of the first set of legs 40 and additionally through a longitudinal slot 24 in the platform 20. As the first set of legs 40 rotate between the transport position (FIG. 10a) and the use position (FIGS. 1, 10e), the pin 46 slides from one end of the slot 24 to the other. When the pin 46 reaches the end of the slot 24 corresponding to the use position, the first hook 86 engages the pin 46, which prevents the pin 46 from sliding within the slot 24 toward the transport position, and rigidly maintains the first set of legs 40 in the use position.

The second hook 88 of the locking bracket 80 selectively retains the first set of legs 40 in the transport position. As best understood with reference to FIGS. 10d and 10e, when the first set of legs 40 is folded to be oriented in parallel to the platform 20, (i.e. the transport position) the pin 46 slides to the opposite end of the slot 24 as guided by the link 70. As the pin 46 slides within the slot 24, the first end of each leg 42 within the first set of legs 40 translates along the slot 24. With sufficient translation, the second hook 88 of the bracket 80 engages an aperture 54 defined within the cross member 44 to prevent relative motion between the first set of legs 40 and the bracket 80. In some embodiments, two or more second hooks 88 are provided that engage two or more apertures 54. Because the bracket 80 is biased toward engagement with the aperture 54, the first set of legs 40 are releasably retained in the transport position. The first set of legs 40 is in the transport position, at least a portion of the first set of legs 40 extend in parallel to and along the length of the slot 24. Accordingly, because a portion of the first set of legs 40 extends along the length of the slot 24 when in the transport position, the length of the first set of legs 40 can be maximized while minimizing the overall length of the stand 10 when in the transport position (i.e. the distance between the first handle 140 and the wheel 48 and the stopping leg 52 when in the transport position shown in FIG. 10a).

A first handle 140 extends from the second end 22 of the platform 20 and provides a member for the user to hold when the stand 10 is in the transport position. The handle 140 also provides as well as a member suitable for holding when the stand 10 is being folded and unfolded between the use and transport positions. The first handle 140 may be “C” shaped with a first end 141 that is attached to the platform 20 and a second end 142 that may be connected to the hinge member 26. The first handle 140 may be two or more members that attach to different sides of the platform 20 and the hinge member 26, which may be connected together with a cross member 143. In some embodiments, the cross member 143 is connected to the hinge member 26.

The first handle 140 is ergonomically designed such that a user can fold the second set of legs 60 between transport position and the use position without removing their hand or altering their grip on the first handle 140. Specifically, as the platform 20 is rotated from the transport position to the use position the user's hand can slide along the first handle 140, without requiring a change in the gripping position, requiring significantly bending or straightening their wrist or elbow, or rotating their shoulder. Further, the user can rotate the stand 10 between a substantially perpendicular “hand truck” position (FIG. 10a with the platform 20 substantially perpendicular or at a large acute or small obtuse angle with respect to the floor) to a “wheel barrow” position (similar to that shown in FIG. 10c although with the second set of legs 60 parallel to the platform 20) without the user removing their hand or altering their grip on the first handle 140.

A second handle 150 extends from the first end 21 of the platform 20 and provides the user an ergonomic structure to hold when transferring the first set of legs 40 from the use position to the transport position against the biasing force of the biasing member 28 on the pin 46. The second handle 150 may be formed as a “C” or with another suitable shape to allow the user to easily hold the second handle 150. In some embodiments, each end of the C-shaped second handle 150 is mounted to the platform 20. The second handle 150 may be mounted such that the second handle 150 surrounds a portion of the actuator 82 of the bracket 80. Further, the second handle 150 provides an ergonomic structure to hold when transferring the first set of legs 40 from the transport position to the use position.

Turning now to FIGS. 1, 2, and 4-8c, a telescopic extension arm 100 is provided to receive and support a workpiece roller support 104. An inserted end 102 of the extension arm 100 linearly telescopes within a track or sleeve in the platform 20 to alter the distance the extension arm 100 extends linearly from the platform 20. A workpiece roller support 104 with an associated roller is slidable along the extension arm 100 to change the distance of the roller support 104 from the work zone of the tool attached to the stand 10. The workpiece roller support 104 is adjustable to vary the height of the roller above the extension arm 100 and can be locked in a specific orientation and position on the extension arm 100. The workpiece roller support 104 is removable from the extension arm by sliding it past the extended end 101 of the extension arm 100 (with the support and adjustment legs 110, 120 telescopically received within the extension arm 100, as discussed below).

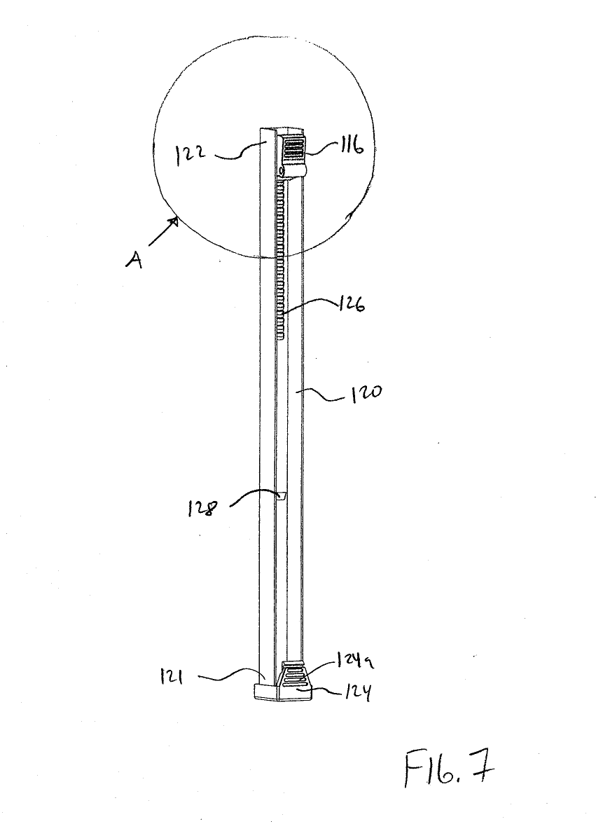

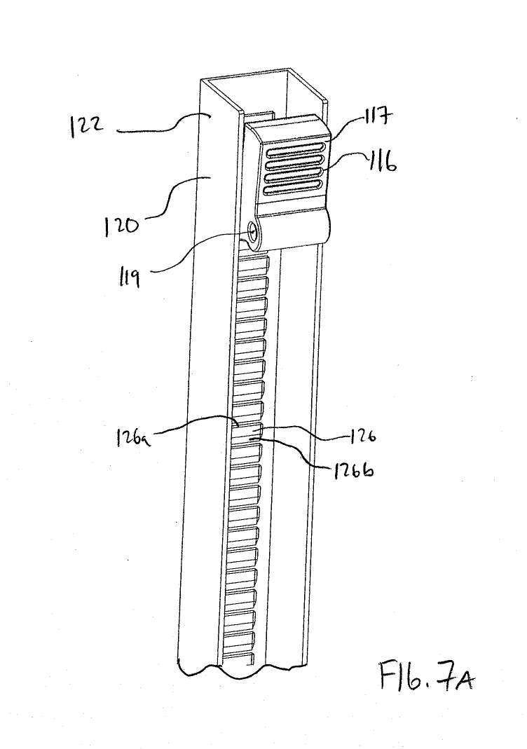

A support leg 110 is pivotably and telescopically connected to the extended end 101 of the extension arm 100. A first end 111a of the support leg 110 receives a pin 112 that extends through a knuckle 114. A portion of the knuckle 114 is received within the extension arm 100 and prevents it from being withdrawn from the extended end 101 of the extension arm 100 and an alternate portion of the knuckle 114 is extendable through the opening in the extended end 101 of the extension arm 100. The extended end 101 of the extension arm 100 may include an upstanding tab 108 (shown with dotted lines on FIGS. 8a-8c) that extends upwardly into the internal volume of the extension arm 100, which prevents the knuckle 114 from being withdrawn from the extended end 101 of the extension arm 100. The knuckle 114 (and support and adjustment legs 110, 120 if connected to the knuckle 114 by the pin 112) are connected to the extension arm 100 by threading them through the inserted end 102 of the extension arm 100 toward the extended end 101. The external volume of the support leg 110 (including the release lever bracket 115, discussed below) is smaller than the internal volume of the extension arm 100 including the tab 108 to allow the support leg 110 (and adjustment leg 120) to telescope within the extension arm 100.

The support leg 110 is formed from an elongate hollow member. The support leg 110 includes an release lever bracket 115 that rotatably supports a release lever 116 that selectively engages an adjustment leg 120 telescopically inserted through the second end 111b of the support leg 110. The adjustment leg 120 is movable and lockable with respect to the support leg 110 to allow for precise height adjustment of the column (formed by the support and adjustment legs 110, 120) that provides mechanical support for the extended end 101 of the extension arm 100 and that allows the roller support 104 to be level with the table surface of the tool connected with the saw stand 10.

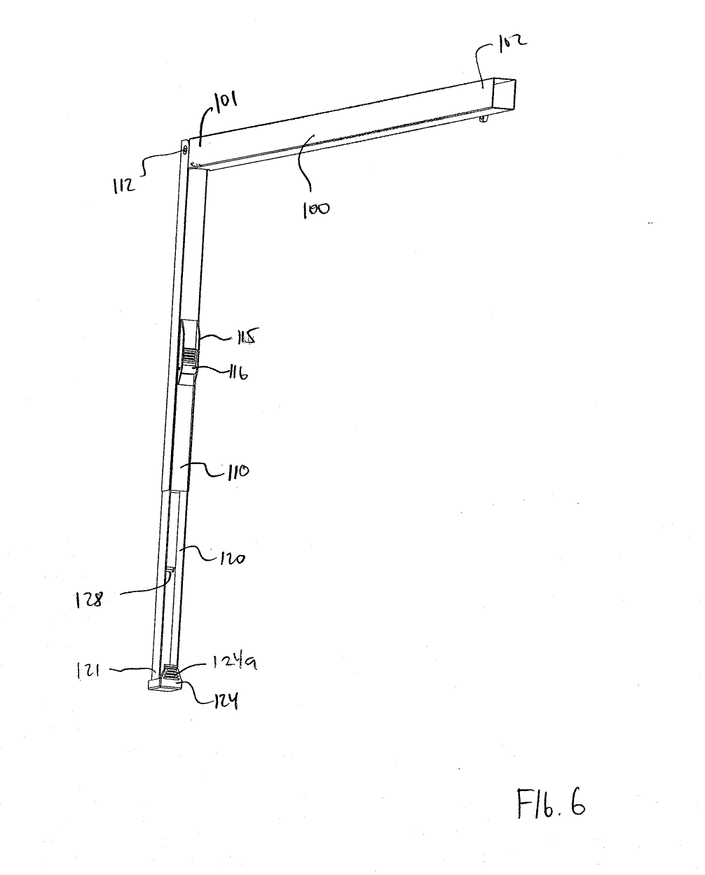

The release lever 116 is pivotally connected to the release lever bracket 115 and biased by a biasing member (not shown) to engage one of a plurality of teeth 126 formed on the adjustment leg 120. As best shown in FIG. 7B, the release lever 116 includes an operable portion 117 that extends from a window in the support leg 110 to allow the user to manipulate the operable portion 117 and a locking portion 118 that is engageable with one of the plurality of teeth 126 defined on the adjustment leg 120. The release lever 116 is biased into engagement between the locking portion 118 and the teeth 126 with a spring or similar biasing member (not shown), which is releasable by pressing the operable portion 117 against the biasing force of the spring.

The adjustment leg 120 is formed from an elongate member. In some embodiments, the adjustment leg 120 has a cross-sectional profile that is substantially C-shaped. The adjustment leg 120 includes a plurality of parallel teeth 126 that are defined to extend from the middle side of the C and extend into the internal volume of the C. The teeth 126 each include a flat top surface 126a and an inclined surface 126b. As best understood with reference to FIGS. 7A and 7B, the locking portion 118 of the release lever 116 engages the teeth 126 in a ratcheting fashion that allows the adjustment leg 120 to be freely withdrawn from the support leg 110, but requires the operable portion 117 of the release lever 116 to be depressed to allow the adjustment leg 120 to be telescopically inserted into the support leg 110. Specifically, when the adjustment leg 120 is withdrawn from the support leg 110, the relative motion causes the release lever 116 to pivot, and the locking portion 118 slides along the inclined surface 126b to allow the adjustment leg 126 to be withdrawn.

When the adjustment leg 120 is pressed to move telescopically into the support leg 110 (or when the adjustment leg 120 feels a compressive force when arranged on the ground as shown in FIG. 1), the release lever 116 is prevented from rotation due to the biased engagement between the locking portion 118 and the flat surface 126a of the teeth 126. When the operable portion 117 of the release lever 116 is pressed against the biasing force of the biasing member, the locking portion 118 of the release lever 116 is rotated away from contact with the flat surface 126a of the teeth 126 and the adjustment leg 120 can be telescopically inserted into the support leg 110. The adjustment leg 128 additionally may include a lock aperture 128 defined between the bottom most tooth 126 and the extended end 121, which receives the locking portion 118 of the release lever 116 to lock the adjustment leg 120 into a position fully inserted within the support leg 110.

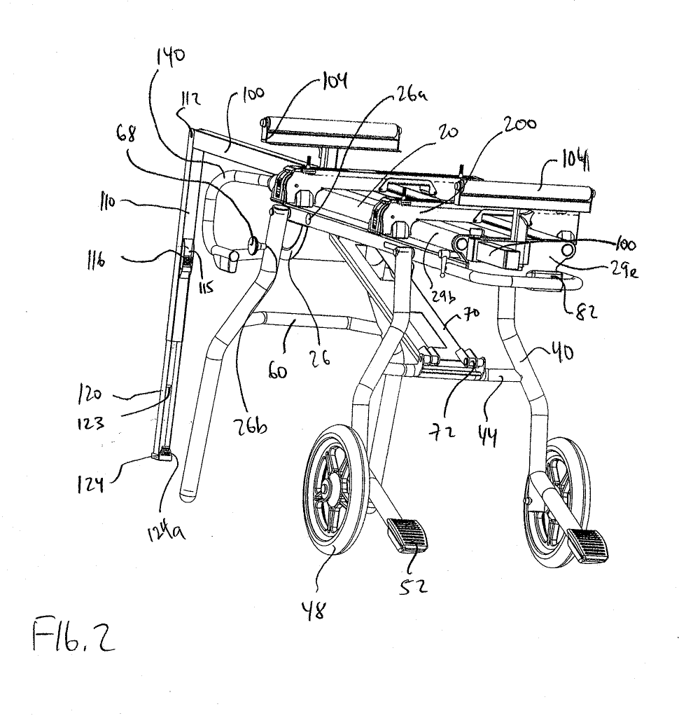

The adjustment leg 120 may include a foot 124 that extends from the extended end 121 of the adjustment leg 120. The foot 124 may be slightly larger than the internal volume of the extension arm 100 to prevent the adjustment leg 120 and the support leg 110 from being fully inserted into the extension arm. The foot 124 may include a finger 124a (FIG. 2) that engages the upstanding tab 108 when the adjustment leg 120 is fully extended into the extension arm 100 to retain the support and adjustment legs 110, 120 telescopically inserted into the extension arm 100. The foot 124 may additionally provide a high friction surface for engagement between the adjustment leg 120 and the ground when the table 10 is in the use position and the extension arm 100 is extended from the platform 20.

In use and with reference to FIGS. 10a-10e, the stand 10 can be folded from a transport position to a use position using the following steps. Initially, as shown in FIG. 10a, when the stand 10 is in the transport position, each of the first and second sets of legs 40, 60 are arranged generally parallel to the platform 20 and locked in position by the bracket 80 and the locking member 68, respectively. As shown in FIGS. 10b and 10c, the second set of legs 60 are unlocked and rotated to a position substantially perpendicular to the platform 20 by withdrawing the locking member 68 from the first hole 26a in the hinge member 26 nearest the second end 22 of the platform 20, rotating the first set of legs 60, and releasing the locking member 68 to enter the second hole 26b (FIG. 2) in the hinge member 26. After the second set of legs 60 are rotated to the use position, the user rotates the platform 20 while holding the first handle 140 until the second set of legs 60 and the wheels 48 contact the ground.

Next, the first set of legs 40 are rotated to the use position, as shown in FIGS. 10d and 10e. When the first set of legs 40 are in the transport position, the user holds the second handle 150 with a first hand and presses the actuator 82 on the bracket 80 with their opposite hand, which causes the bracket 80 to rotate against the biasing force of the spring 90. Rotation of the bracket 80 causes the second hook 88 to withdraw from the aperture 54 on the cross member 44 of the first set of legs 40, which allows the first set of legs 40 to rotate. When the second hook 88 is released from the aperture 54, the first set of legs 40 automatically rotate toward the open position due to the biasing force of the biasing member 28 on the pin 46 that extends through the slot 24. Specifically, the biasing member 28 causes the pin to translate to the opposite end of the slot 24, which causes the first set of legs 40 to rotate to the use position. The motion of the first set of legs 40 is constrained by the link 70, which is pinned on opposite ends to the platform 20 and the first set of legs 40. When the pin 46 reaches the opposite end of the slot 24, the first hook 86 engages the pin 46 and the first set of legs 40 are retained in the use position as shown in FIG. 10e.

When the stand 10 is in the use position, the extension arms 100 may be withdrawn and the roller supports 104 may be installed. Next, the support and adjustment legs 110, 120 may be telescopically withdrawn from the extension arm 100, rotated into position substantially perpendicular to the extension arm 100. Finally, the support and adjustment legs 110, 120 are adjusted to meet the height of the extended end 101 of the extension arm 100 above the ground to mechanically support the extended end 101 of the extension arm 100. The support and adjustment legs 110, 120 are locked into position into position with respect to the extension arm 100 with a lock 114. The support and adjustment legs 110, 120 are locked into position with respect to each other due to the ratcheting engagement between the locking portion 118 of the release lever 116 and the teeth 126 defined within the adjustment leg 120.

The stand 10 is folded to the transport position in the opposite manner than the stand 10 is unfolded from the transport position. Initially, the user holds the second handle 150 with a first hand and presses the actuator 82 with their opposite hand. When the actuator 82 is pressed, the bracket 80 rotates against the biasing force of the spring 90 and the first hook 86 disengages the pin 46. The user then presses the second handle 150 downward toward the wheels 48 (as shown with reference to FIGS. 10e and 10d), which allows the pin 46 to slide within the slot 24 against the biasing force of the biasing member 28 that engages the pin 46. As the pin 46 slides through the slot 24, the first set of legs 40 rotate toward a position parallel with the platform 20, due to their connection with the link 70. When the pin 46 reaches the opposite end of the slot 24, the first set of legs 40 are substantially parallel to the platform 20 and the second hook 88 engages the aperture 54 in the cross member 44.

Next, the user withdraws the locking member 68 from the second hole 26b in the hinge 26 and presses down on the first handle 140, causing the second set of legs 60 to rotate toward a position substantially parallel to the platform 20, i.e. the transport position. When the second set of legs 60 reach the transport position, the user inserts the locking member 68 into the first hole 26a on the hinge 26 to retain the second set of legs 60 in the transport position.

It is apparent that apparatus incorporating modifications and variations to the foldable stand 10 of the present invention described above will be obvious to one skilled in the art. Inasmuch as the foregoing disclosure is intended to describe the present invention the above description should not be construed to limit the present invention but should be construed to include any obvious variations and should be limited only by the spirit and scope of the following claims. It is therefore intended that the foregoing detailed description be regarded as illustrative rather than limiting, and that it should be understood that it is the following claims, including all equivalents, that are intended to define the spirit and scope of this invention.

What is claimed:

1. A stand comprising:
a platform;
a first leg rotatably mounted to the platform; and
a bracket mounted to the platform comprising a first hook engageable with a first portion of the first leg to maintain the first leg in a first position, and a second hook engageable with a second portion of the first leg to maintain the first leg in a different second position.

2. The stand of claim 1, further comprising a second leg rotatably mounted to the platform at a location remote from the first leg.

3. The stand of claim 1, wherein the first leg further comprises a pin that is slidingly received within a slot in the platform.

4. The stand of claim 3, wherein the first hook is engageable with the pin when the second leg is in the first position.

5. The stand of claim 3, further comprising a biasing member connected to the platform and engaged with the pin to urge the first leg into the first position.

6. The stand of claim 1, wherein the first leg includes an aperture on the second portion that receives the second hook when the first leg is in the second position.

7. The stand of claim 1, wherein the bracket further comprises an actuator, wherein rotation of the actuator in a first direction disengages engagement between the first hook and the first portion and the second hook and the second portion.

8. The stand of claim 7, wherein the bracket is biased to urge engagement between the first hook and the first portion and the second hook and the second portion.

9. A stand comprising:
a platform;
a plurality of legs rotatably mounted to the platform;
an extension arm, telescopically mounted to the platform; and
a support leg rotatably and telescopically mounted to the extension arm.

10. The stand of claim 9, further comprising an adjustment leg telescopically mounted to the support leg.

11. The stand of claim 9, wherein the support leg is rotatable from a position to allow for telescoping into the extension arm, to a position substantially perpendicular to the extension arm.

12. The stand of claim 11, further comprising a lock that selectively rigidly maintains the support leg substantially perpendicular to the extension arm.

13. The stand of claim 10, further comprising a release lever pivotally mounted to the support leg and engageable with a portion of the adjustment leg telescopically received within the support leg.

14. The stand of claim 13, wherein the adjustment leg comprises a plurality of teeth defined along at least a portion of the length of the adjustment leg.

15. The stand of claim 10, wherein the support leg has a cross-sectional profile that is generally C-shaped and the adjustment leg telescopes within an internal portion of the C.

16. The stand of claim 9, further comprising a workpiece support mounted on and removable from the extension arm.

17. The stand of claim 16, wherein the workpiece support is removable from the extension arm when the support leg is telescopically received within the extension arm.

18. The stand of claim 1, further comprising a support handle configured to allow for rotation of the platform from a horizontal use position to an oblique transportation position without at least one of the user's hands being removed from the handle.

19. The stand of claim 18, wherein the support handle is substantially C shaped with a first end of the C rigidly mounted to the platform and a second end of the C mounted to a bracket that receives a second leg rotatably mounted to the platform.

20. A stand comprising:
a platform;
a first leg rotatably mounted to the platform; and
a bracket mounted to the platform comprising a hook engageable with a first portion of the first leg to maintain the leg in an extended position with respect to the platform.

21. The stand of claim 20, wherein the bracket further comprises a second hook engageable with a second portion of the leg to maintain the leg in a retracted position with respect to the platform.

22. The stand of claim 20, wherein the platform comprises two parallel hollow beams joined together with a plurality of cross members and an arcuate surface formed on opposite sides of each hollow beam.

23. The stand of claim 22, further comprising a removable mounting bracket that is lockingly engageable with the arcuate surfaces on the two beams.

24. The stand of claim 20, wherein the platform comprises a slot that slidably receives the first leg.

25. The stand of claim 24, wherein the first leg is rotatable to a substantially parallel position with respect to the platform, wherein a portion of the first leg extends along the length of the slot.
